(19) United States
(12) Patent Application Publication
(10) Pub. No.: US 2004/0151091 A1
(43) Pub. Date: Aug. 5, 2004

(54) Optical information reproducing apparatus and method

(75) Inventors: Byung-in Ma, Gyeonggi-do (KR); In-sik Park, Gyeonggi-do (KR); Chong-sam Chung, Gyeonggi-do (KR); Kyung-geun Lee, Gyeonggi-do (KR); Hyun-soo Park, Seoul (KR); Jae-seong Shim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon city (KR)

(21) Appl. No.: 10/712,304

(22) Filed: Nov. 14, 2003

(30) Foreign Application Priority Data
Dec. 3, 2002 (KR) 2002-76221

(51) Int. Cl. G11B 7/005

(52) U.S. Cl. 369/47.22

(57) ABSTRACT

An apparatus for and a method of reproducing information from an optical information storage medium (OISM) in which inherent information and control data are recorded according to a bi-phase modulation method and other data are recorded according to a general modulation method. Sum signals of signals reflected from the OISM are determined. A ROM-PIC demodulator demodulates optical information storage medium-related information (OISMRI) from the sum signal. A data demodulator demodulates reproduction-related user data from the sum signal, a wobble PIC demodulator demodulates recordable OISMRI recorded as pit wobbles from a differential signal of the reflected signals, and a wobble PID demodulator demodulates physical identification data that is recorded as pit wobbles from the differential signal. A determination is made whether the OISM is a read-only OISM or a recordable OISM based on whether the optical information storage medium comprises a plurality of different modulation codes.

### CROSS-REFERENCE TO RELATED APPLICATIONS

This application claims the priority of Korean Patent Application No. 2002-76221, filed on Dec. 3, 2002, in the Korean Intellectual Property Office, the disclosure of which is incorporated herein by reference.

### BACKGROUND OF THE INVENTION

1. Field of the Invention

The present invention relates to an apparatus for and a method of reproducing information from an optical information storage medium, and more particularly, to an apparatus for and method of reproducing information from an optical information storage medium in which inherent information about the storage medium and control data are recorded according to a bi-phase modulation method and other data are recorded according to a general modulation method.

2. Description of the Related Art

Optical discs are generally used as information storage media of optical pickup devices which record information on and/or reproduce information from the optical discs in a non-contact manner. Optical discs may be classified as either compact discs (CDs) or digital versatile discs (DVDs) according to their information recording capacity. CDs and DVDs may further include, e.g., 650 MB CD-Rs, CD-RWs, 4.7 GB DVD+RWs, DVD-random access memories (DVD-RAMs), and DVD-R ewritables (DVD-RWs). Read-only discs may include, e.g., 650 MB CDs and 4.7 GB DVD-ROMs. Further, high-density digital versatile discs (HD-DVD) having a recording capacity of 23 GB or more have been developed.

The above-mentioned optical information media are standardized according to their types so as to be compatibly used in different reproducing devices. Thus, users can conveniently use the optical information media and a cost for purchasing different types of reproducing devices may be saved.

General optical information storage media use a method of recording data as pits or groove wobbles. Here, pits are miniature scratches that are physically formed in a substrate while manufacturing a disc, and groove wobbles are grooves that are formed in a waveform. A pit signal is detectable as a jitter value while a groove wobble signal is detectable as a push-pull signal.

Referring to FIG. 1, a conventional HD-rewriteable (HD-RW) optical storage medium 10 comprises a data area 13 in which user data are recorded, a lead-in area 11 which is formed inside the data area 13, and a lead-out area 15 which is formed outside the data area 13. Here, a storage medium-related information area 17 is prepared in the entire lead-in area 11 or a portion of the lead-in area 11, and read-only data such as storage medium-related information and the like is recorded in the storage medium-related information area 17. The read-only data are recorded in a relatively high frequency wobble form. Data are recorded in a relatively low frequency wobble form in a recordable area 19 in which the user data are recorded in grooves. The recordable area 19 is formed in a portion of the lead-in area 11, the data area 13, and the lead-out area 15. Accordingly, an entire surface of the HD-RW storage medium 10 is formed in a groove form to prevent the deterioration of a radio frequency (RF) signal due to a difference between an amount of transmitted light and an amount of reflected light when grooves are mixed with pits.

A HD-read only memory (HD-ROM), which complies with the same physical format such as a modulation method, a minimum pit length, a track pitch, or the like, contains user data such as contents recorded in advance when a substrate is manufactured. Thus, the storage medium-related information may be recorded as pits instead of groove wobbles in the storage medium-related information area 17 corresponding to the portion of the lead-in area 11 when the substrate is manufactured.

### SUMMARY OF THE INVENTION

The present invention provides an apparatus for and a method of reproducing optical information recorded on an optical information storage medium and a recordable optical information storage medium in which inherent information about the storage medium and control data are recorded according to a bi-phase modulation method and other data are recorded according to a general modulation method.

According to an aspect of the present invention, there is provided an optical information reproducing apparatus for reproducing information from an optical information storage medium which comprises a lead-in area, a user data area, and a lead-out area, wherein optical information storage medium-related information is recorded in an entire lead-in area or a portion of the lead-in area and reproduction-related user data are recorded in a remaining area of the optical information storage medium. The optical information reproducing apparatus comprises: a light source which radiates a laser light beam; an objective lens which condenses the laser light beam to be focused on the optical information storage medium; a photodetector which receives the laser light beam reflected from the optical information storage medium and which comprises first and second photodiodes which convert a received optical signal into independent electric signals; a data demodulator which demodulates the reproduction-related user data from a sum signal of the electric signals detected by the first and second photodiodes; and a read only memory-permanent information and control (ROM-PIC) data demodulator which demodulates the optical information storage medium-related information from the sum signal.

According to another aspect of the present invention, there is provided an optical information reproducing apparatus for reproducing information from a read-only optical information storage medium which comprises a lead-in area, a user data area, and a lead-out area, wherein read-only optical information storage medium-related information is recorded in at least a portion of the lead-in area and reproduction-related user data are recorded in a remaining area of the read-only optical information storage medium, or for recording reproducing information from a recordable optical information storage medium which comprises a lead-in area, a user data area, and a lead-out area, whereon recordable optical information storage medium-related information is recorded as pit wobbles in the entire lead-in area or a portion of the lead-in area and recording- and reproduction-related user data are recorded in a remaining area of the recordable optical information storage medium. The optical information reproducing apparatus comprises: a light source which radiates a laser light beam; an objective lens which condenses the laser light beam to be focused on the read-only optical information storage medium or the recordable optical information storage medium; a photodetector that receives the laser light beam reflected from the read-only optical information storage medium or the recordable optical information storage medium and comprises first and second photodiodes that independently convert a received optical signal into an electric signal; a data demodulator that demodulates the reproduction-related user data from a sum signal of signals detected by the first and second photodiodes; a read only memory-permanent information and control data (ROM-PIC) demodulator which demodulates the read-only optical information storage medium-related information from the sum signal; a wobble PIC demodulator that demodulates the recordable optical information storage medium-related information that is recorded as pit wobbles, from a differential signal of the signals detected by the first and second photodiodes; and a wobble physical identification data (PID) demodulator which demodulates physical identification data that are recorded as pit wobbles on the recordable optical information storage medium, from the differential signal of the signals detected by the first and second photodiodes. The optical information reproducing apparatus reproduces information from the read-only optical information storage medium using signals obtained from the data demodulator and the ROM-PIC demodulator, while the optical information reproducing apparatus reproduces information from the recordable optical information storage medium using signals obtained from the data demodulator, the wobble PIC demodulator, and the wobble PID demodulator.

According to still another aspect of the present invention, there is provided an optical information reproducing method of reproducing information from an optical information storage medium which comprises a lead-in area, a user data area, and a lead-out area, whereon optical information storage medium-related information is recorded in the entire lead-in area or a portion of the lead-in area and reproduction-related user data are recorded in a remaining area of the optical information storage medium. The optical information reproducing method comprises: radiating a laser light beam onto the optical information storage medium; receiving the laser light beam reflected from the optical information storage medium using a photodetector comprising first and second photodiodes that independently convert a received optical signal into an electric signal; demodulating the reproduction-related user data from a sum signal of signals detected by the first and second photodiodes; and demodulating the optical information storage medium-related information from the sum signal.

According to yet another aspect of the present invention, there is provided an optical information reproducing method of recording information on and/or reproducing information from a read-only optical information storage medium which comprises a lead-in area, a user data area, and a lead-out area, where read-only optical information storage medium-related information is recorded in the entire lead-in area or a portion of the lead-in area and reproduction-related user data are recorded in a remaining area of the read-only optical information storage medium, or recording information on and/or reproducing information from a recordable optical information storage medium which comprises a lead-in area, a user data area, and a lead-out area, whereon recordable optical information storage medium-related information is recorded as pit wobbles in the entire lead-in area or a portion of the lead-in area and reproduction-related user data are recorded in a remaining area of the recordable optical information storage medium. The optical information reproducing method comprises: radiating a laser light beam; receiving the laser light beam reflected from the read-only optical information storage medium or the recordable optical information storage medium using a photodetector comprising first and second photodiodes that independently convert a received optical signal into an electric signal; determining whether the read-only optical information storage medium or the recordable optical information storage medium is used depending on whether a differential signal of signals detected by the first and second photodiodes comprises a wobbling signal; demodulating the reproduction-related user data from a sum signal of signals detected by the first and second photodiodes; demodulating the read-only optical information storage medium-related information from the sum signal using a ROM-PIC demodulator when the read-only optical information storage medium is used; and when the recordable optical information storage medium is used, demodulating the recordable optical information storage medium-related information that is recorded as pit wobbles, from the differential signal of the signals detected by the first and second photodiodes using a wobble PID demodulator and demodulating physical identification data that are recorded as pit wobbles on the recordable optical information storage medium, from the differential signal of the signals detected by the first and second photodiodes using a wobble PID demodulator.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of the embodiments taken in conjunction with the accompanying drawings in which:

FIG. 1 schematically illustrates a structure of a conventional optical information storage medium;

FIG. 2 schematically shows an optical arrangement of an optical head unit used for an optical information reproducing apparatus;

FIG. 3 schematically shows a photodetector shown in FIG. 2;

FIG. 4 schematically shows a demodulator unit used for a general read-only optical information storage medium;

FIG. 5 schematically illustrates a structure of a read-only optical information storage medium;

FIG. 6 shows a demodulator unit for an optical information reproducing apparatus according to an embodiment of the present invention;

FIG. 7 shows a demodulator unit used for a general recordable optical information storage medium; and

FIG. 8 shows a demodulator unit for an optical information reproducing apparatus according to another embodiment of the present invention

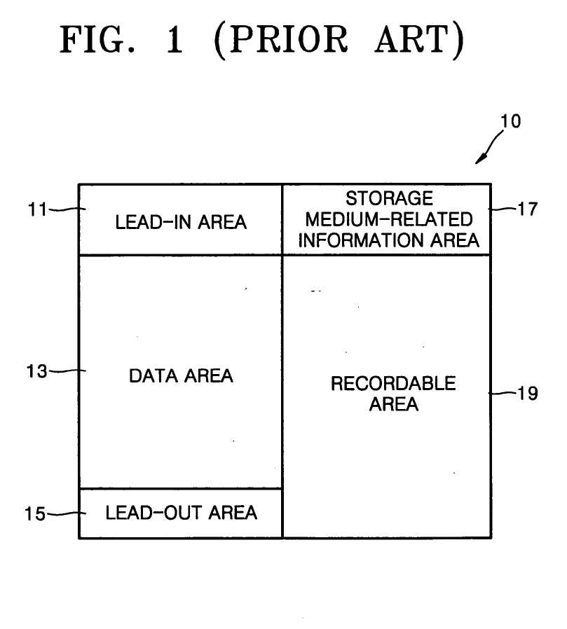

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

An optical information reproducing apparatus according to the present invention comprises an optical head unit, a signal demodulator unit and a signal processor.

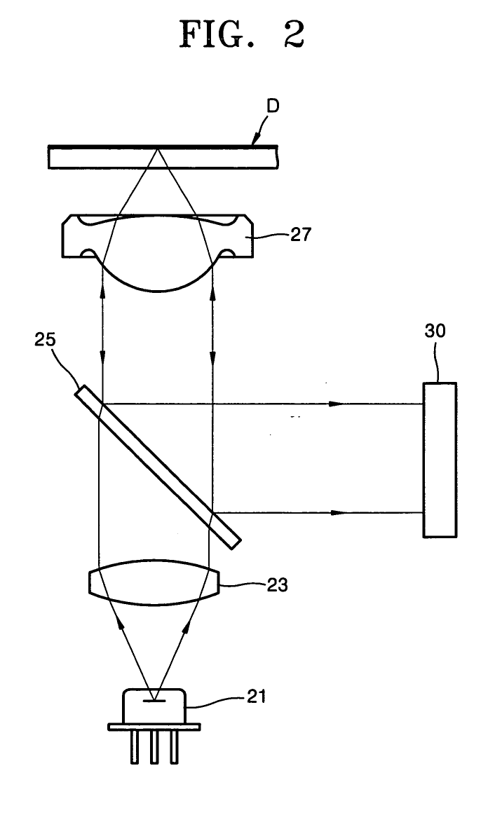

Referring to FIG. 2, the optical head unit comprises a light source 21 which radiates a laser light beam, an objective lens 27 which condenses the laser light beam to form an optical spot on an optical information storage medium D, and a photodetector 30 which receives the laser light beam reflected from the optical information storage medium D.

The optical information reproducing apparatus further comprises a beam splitter 25 which transmits at least a portion of the laser light beam emitted from the light source 21 toward the optical information storage medium D and reflects at least a portion of the laser light beam reflected from the optical information storage medium D toward the photodetector 30; and a collimating lens 23, disposed between the light source 21 and the beam splitter 25 and which condenses a divergent light beam radiated from the light source 21 to make the divergent light beam into a parallel light beam.

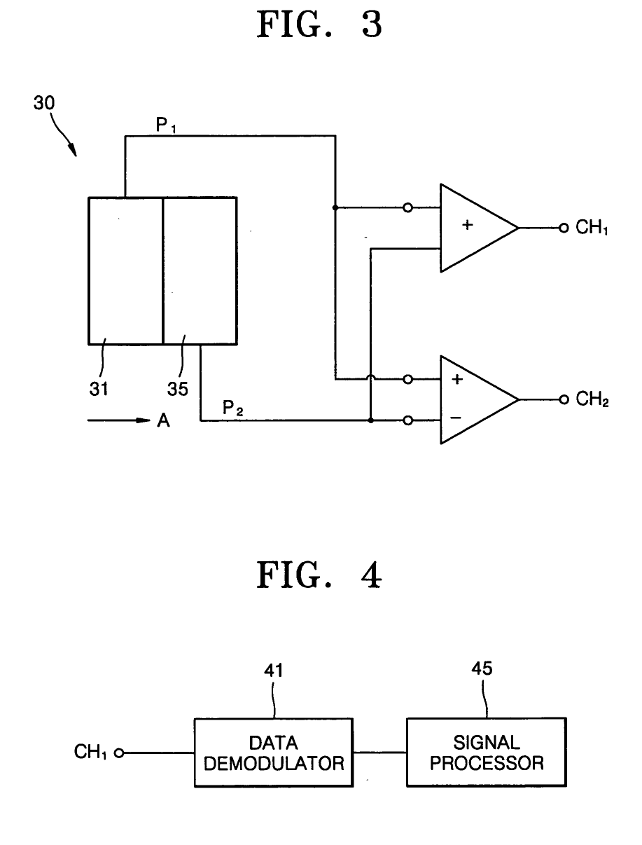

Referring to FIG. 3, the photodetector 30 comprises first and second photodiodes 31 and 35 which independently convert respective optical signals into respective electric signals. The first and second photodiodes 31 and 35 have a two-division structure so as to be symmetrical in a tangential direction of the optical recording medium as indicated by arrow A.

Here, when the first and second photodiodes 31 and 35 output signals P₁ and P₂, respectively, a sum signal S output via a first channel CH₁ and a differential signal D output via a second channel CH₂ may be defined as in Equations 1A and 1B, respectively:

S=P₁+P₂ (1A)

D=P₁−P₂ (1 B)

When the optical information reproducing apparatus according to the present invention reproduces signals from a read-only optical information storage medium and a recordable optical information storage medium using the optical head unit having the above-described structure, the optical information reproducing apparatus uses the first and second channels CH₁ and CH₂ in different ways, as is explained below.

Prior to the description of a demodulator and a signal processor of the optical information reproducing apparatus according to the present invention, reproduction of information from a general read-only storage medium, such as for example, a ROM disc, on which a write signal is recorded as a pit will be explained.

In a case of the general read-only storage medium, data demodulating and signal processing are performed using only the sum signal S output via the first channel CH₁. In other words, an additional structure is not needed to demodulate storage medium-related information recorded on the general read-only storage medium. As shown in FIG. 4, a data demodulator 41 demodulates a signal input via the first channel CH₁ and a signal processor 45 reproduces the demodulated signal. Accordingly, the optical information reproducing apparatus having structure as described with respect to FIG. 4 cannot reproduce information from an optical information storage medium on which inherent information about the storage medium and control data are recorded according to a bi-phase modulation method and other data are recorded according to a general modulation method.

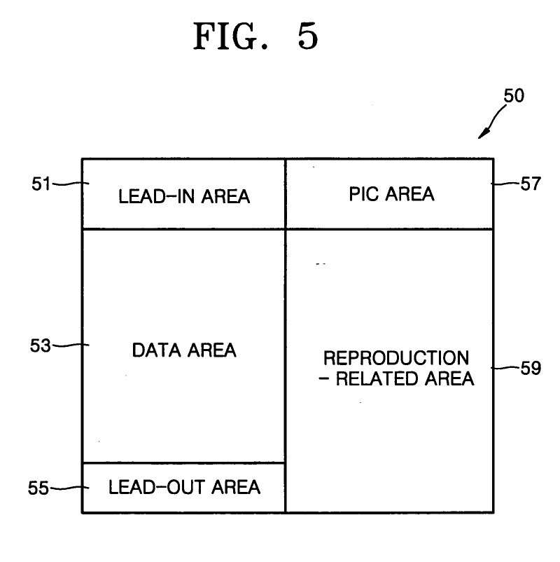

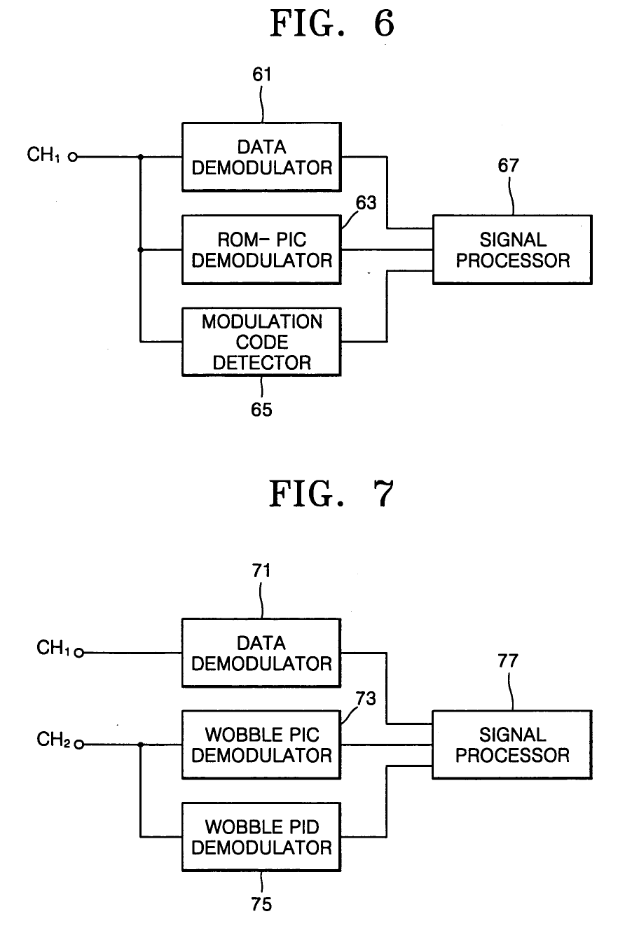

According to an aspect of the present invention, the optical information reproducing apparatus reproduces information from a read-only optical information storage medium 50 having a structure as shown in FIG. 5 and comprises the optical head unit shown in FIG. 2, a data demodulator 61, a ROM-permanent information and control data (PIC) demodulator 63, and a signal processor 67 as shown in FIG. 6.

Referring to FIG. 5, the read-only optical information storage medium 50 comprises a lead-in area 51, a user data area 53, and a lead-out area 55. Here, a PIC area 57 in which permanent information and control (PIC) data, are recorded as pit wobbles is formed in the entire lead-in area 51 or a portion of the lead-in area 51. A reproduction-related area 59 in which user data are recorded as general pits is formed in the remaining area of the read-only optical information storage medium 50. The pit wobble refers to a sequence of pits arranged in a waveform, and the general pits refer to pits arranged in a line.

Data are recorded as pits in both the PIC area 57 and the reproduction-related area 59 using different modulation codes. In other words, the PIC data are recorded in the entire lead-in area 51 or the portion of the lead-in area 51 according to the bi-phase modulation method and reproduction-related data are recorded in the user data area 53 according to a run length-limited (RLL) modulation method.

The RLL modulation method indicates how many successive zeros exist between “1” bits. Thus, RLL (d, k) represents that a minimum number and a maximum number of successive zeros between “1” bits are “d” and “k”, respectively. The bi-phase modulation method is a method of recording data depending on whether a predetermined signal varies within a predetermined period. For example, when the phase of a groove wobble does not change within a predetermined period, data bits of value “0” are recorded. In contrast, when the phase of the groove wobble changes within the predetermined period, data bits of value “1” are recorded.

Referring to FIG. 6, the data demodulator 61 and the ROM-PIC demodulator 63 demodulate the reproduction-related user data and the PIC data, respectively, input via the first channel CH₁. Here, the data demodulator 61 reproduces the reproduction-related user data that are recorded on the read-only optical information storage medium 50 according to the RLL modulation method. The ROM-PIC demodulator 63 reproduces the PIC data that are recorded on the read-only optical information storage medium 50 according to the bi-phase modulation method.

The data demodulator 61 may reproduce information from the read-only optical information storage medium 50 using an RLL (1, 7) modulation method. In the RLL (1, 7) modulation method, a minimum number and a maximum number of successive zeros existing between “1” bits are 1 and 7, respectively. According to the RLL (1, 7) modulation method, when d=1, data of “1010101” is recorded and thus the length of a mark or a space between two bits of value “1” is 2T Also, when d=7, data of “10000000100000001” is recorded and thus the length of a mark or a space between two bits of value “1” is 8T. Thus, in the RLL (1, 7) modulation method, data are recorded as marks and spaces of length 2T, and marks and spaces of length 8T.

Here, 9T that is not used in the RLL (1, 7) modulation method may be used as a sync pattern. When 6T is determined as a basic period and a signal does not change within the basic period of 6T, data bits of value “0” are recorded. When a signal changes within a period of a pit of length 3T and a space of length 3T, data bits of value “1” are recorded.

The data demodulator 61 may reproduce information from the read-only optical information storage medium 50 using an RLL (2, 10) modulation method. According to the RLL (2, 10) modulation method, data are recorded as pits and spaces with lengths between 3T and 11T.

Data recorded according to the bi-phase modulation method comprises a mark and a space having a length of nT, and a mark and a space having a length of 2nT, wherein n is an integer in a range where 2≦n≦8. For example, if n=2, data recorded according to the bi-phase modulation method includes marks and spaces having a length of 2T, and marks and spaces having a length of 4T. If n=8, data recorded according to the bi-phase modulation method includes marks and spaces having a length of 8T, and marks and spaces having a length of 16T. The bi-phase modulation method uses only 3T/6T/9T. Thus, since the PIC area 57 corresponds to an area in which 3T/6T/9T are concentratedly detected, the PIC area 57 is distinguishable from the reproduction-related data area 59.

In order to check whether the read-only optical information storage medium 50 uses the different modulation codes as described above, the optical information reproducing apparatus according to the present invention may further comprise a modulation code detector 65 which detects a modulation code from the sum signal S input via the first channel CH₁.

The modulation code detector 65 detects the marks and spaces having a length of nT, and the marks and spaces having a length of 2nT recorded according to the bi-phase modulation method to check whether the read-only optical information storage medium 50 includes a plurality of different modulation codes.

In a case where a read-only optical disc is used as the read-only optical information storage medium 50, a lead-in area or a specific area may use a different modulation code from a user data area, which may affect a servo characteristic. Consequently, if magnitudes of a focus error signal and a track error signal detected by the photodetector (30 of FIG. 2) are different from a magnitude of a data signal, the optical information reproducing apparatus may further comprise an adjuster circuit which adjusts the focus error signal and the track error signal.

For example, in an event that the lead-in area or the specific area uses a bi-phase modulation code, an average channel bit length of the read-only optical disc becomes longer than when an RLL (1, 7) modulation code is used in the data area so that an amount of light reflected from the read-only optical disc is affected. As a result, the magnitude of the focus error signal or the track error signal detected from the lead-in area or the specific area becomes different from the magnitude of the data signal detected from the data area. Therefore, the adjuster circuit improves the servo characteristic when a track pitch in the lead-in area or the specific area is different from a track pitch in the data area or a reflectivity varies depending on the modulation code.

Accordingly, the optical information reproducing apparatus having the structure described with respect to FIG. 6 reproduces information from the optical information storage medium having the format described with respect to FIG. 5, i.e., from an optical information storage medium in which inherent information about the storage medium and control data are recorded according to the bi-phase modulation method and other data are recorded according to the general modulation method.

A method of reproducing optical information from the read-only optical information storage medium 50 in which data are recorded as pits in both the PIC area 57 and the reproduction-related area 59 is similar and a separate description thereof will not be provided.

Referring again to FIGS. 2 and 3, the light source 21 radiates a laser light beam onto the read-only optical information storage medium 50. The objective lens 27 condenses the radiated laser light beam to be focused onto the read-only optical information storage medium 50. The photodetector 30 receives the laser light beam reflected from the read-only optical information storage medium 50 via the beam splitter 25. Referring to FIG. 6, the data demodulator 61 demodulates the reproduction-related user data signal from the sum signal S of signals detected by the first and second photodiodes 31 and 35, i.e., the signal input via the first channel CH₁. The ROM-PIC demodulator 63 demodulates the PIC from the signal input via the first channel CH₁.

Here, on the read-only optical information storage medium 50, the reproduction-related user data are recorded according to the RLL modulation method and the PIC data are recorded according to the bi-phase modulation method. As described above, the RLL modulation method may be the RLL (1, 7) modulation method or the RLL (2, 10) modulation method.

Information is recorded as marks and spaces having a length of nT, and marks and spaces having a length of 2nT on the read-only optical information storage medium 50 according to the bi-phase modulation method, wherein n is an integer within a range of 2-8.

The optical information reproducing method according to the present embodiment may further comprise detecting from the signal input via the first channel CH₁ whether the read-only optical information storage medium 50 comprises a plurality of different modulation codes, using the modulation code detector 65. This modulation code detecting method detects types of modulation codes by detecting the mark and the space having a length of nT, and the mark and the space having a length of 2nT recorded according to the bi-phase modulation method.

The above-described optical information reproducing method is applicable to an optical information storage medium having two or more information layers as well as to an optical information storage medium having a single information layer.

When the optical information reproducing apparatus reproduces a signal from the read-only information storage medium via the optical head unit described with reference to FIGS. 2 and 3, the optical information reproducing apparatus uses only the first channel CH₁. However, when the optical information reproducing apparatus reproduces a signal from the recordable optical information storage medium via the optical head unit, the optical information reproducing apparatus uses both the first and second channels CH₁ and CH₂.

In other words, guides with land and groove forms for tracking are formed on a recordable optical information storage medium, e.g., a recordable (R) disc or a rewritable (RW) disc, and the lands and/or grooves wobble in order to record information indicating the position of the recordable optical information storage medium. Thus, besides a data demodulator demodulating the sum signal S output via the first channel CH₁, an additional demodulator is required to demodulate the wobbling signal using the differential signal D output via the second channel CH₂.

Before the demodulator and the signal processor of the optical information reproducing apparatus according to the present invention are described, a method of reproducing information using a general optical information reproducing apparatus will be explained.

Referring to FIG. 7, on the read-only optical information storage medium, the general optical information reproducing apparatus demodulates and processes data using only the sum signal S output via the first channel CH₁. In other words, the general optical information reproducing apparatus requires an additional structure to demodulate the PIC data, demodulates the sum signal S input via the first channel CH₁ using a data demodulator 71, and reproduces the sum signal S using a signal processor 77. When the general optical information reproducing apparatus performs reproduction from the recordable optical information storage medium, the general optical information reproducing apparatus uses both the first and second channels CH₁ and CH₂.

Accordingly, the general optical information reproducing apparatus comprises the data demodulator 71 which demodulates data from the sum signal S input via the first channel CH₁, a wobble PIC demodulator 73 which demodulates a wobble PIC signal from the differential signal D input via the second channel CH₂, and a wobble physical identification data (PID) demodulator 75 which demodulates a PID signal from the differential signal D input via the second channel CH₂. The signal processor 77 reproduces the signals demodulated by the data demodulator 71, the wobble PIC demodulator 73, and the wobble PID demodulator 75.

Reproduction from the recordable optical information storage medium using the general optical information reproducing apparatus having the above-described structure is performed without any problem. However, the general optical information reproducing apparatus cannot reproduce information from the read-only optical information storage medium on which inherent information and control data relating to the read only optical information storage medium are recorded according to the bi-phase demodulation method and other data are recorded according to the general demodulation method.

The optical information reproducing apparatus according to the present invention comprises an improved structure which reproduces information from a general recordable optical information storage medium as well as from the optical information storage medium having formats illustrated with respect to FIG. 5.

The optical information reproducing apparatus according to the second embodiment of the present invention may comprise the optical head unit described with reference to FIG. 2, a demodulator unit 80, and a signal processor 89.

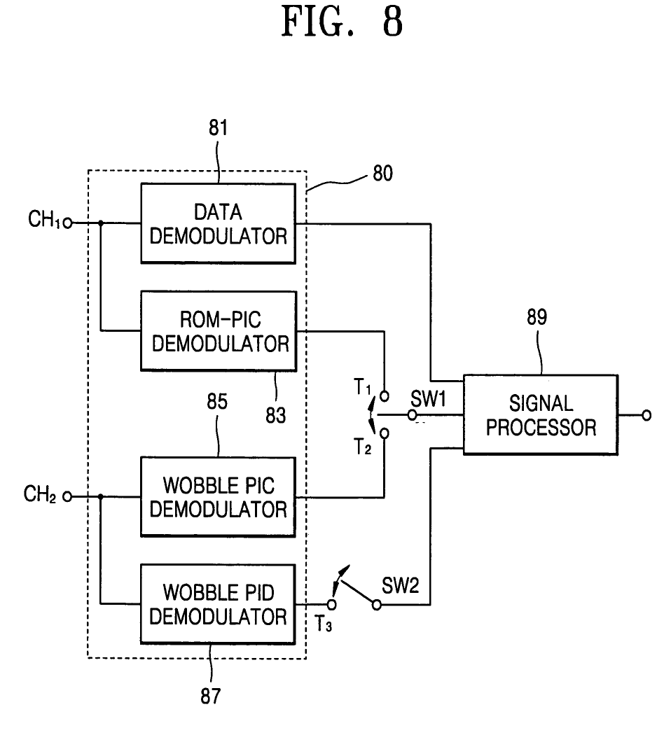

Referring to FIG. 8, the demodulator unit 80 comprises a data demodulator 81 which demodulates the sum signal S input via the first channel CH₁, a ROM-PIC demodulator 83 which demodulates PIC data, a wobble PIC demodulator 85 which demodulates the differential signal D input via the second channel CH₂, and a wobble PID demodulator 87. The demodulating unit 80 is connected to the signal processor 89.

The data demodulator 81 and the ROM-PIC demodulator 83 demodulate reproduction-related user data and the PIC data, respectively, input via the first channel CH₁. The data demodulator 81 reproduces the reproduction-related user data recorded on the optical information storage medium according to the RLL modulation method. Here, the optical information storage medium may be the read-only optical information storage medium or the recordable optical information storage medium. The ROM-PIC demodulator 83 reproduces the PIC recorded on the read-only optical information storage medium 50 of FIG. 5 according to the bi-phase modulation method.

Here, the recordable optical information storage medium comprises a lead-in area in which a wobble PIC area is formed to pre-record manufacturing-related information. The manufacturing-related information recorded in the wobble PIC area is modulated according to a different modulation method from a remaining data area. The wobble PIC demodulator 85 and the wobble PID demodulator 87 are used when demodulating data from the recordable optical information storage medium, and are responsible for demodulation in the PIC area and the remaining data area, respectively.

As described above, the demodulating unit is connected to the signal processor 89. However, this connection is according to the type of optical information storage medium which is used.

In other words, the demodulating unit comprises a switch SW₁ to selectively connect the ROM-PIC demodulator 83 and the wobble PIC demodulator 85 to the signal processor 89 according to the type of optical information storage medium which is used. The demodulating unit further comprises a switch SW₂ to selectively connect the wobble PID demodulator 87 to the signal processor 89.

During reproduction from the read-only optical information storage medium, the switch SW₁ is connected with a node T₁ to connect the ROM-PIC demodulator 83 to the signal processor 89, and the switch SW₂ is opened. Accordingly, when the optical head unit shown in FIG. 2 forms an optical spot in the PIC area of the read-only optical information storage medium, the ROM-PIC demodulator 83 is used. When the optical spot is formed in the remaining area, the data demodulator 81 is used. Here, since data are recorded as different modulation codes in the PIC area and the remaining area, the PIC area can be discriminated from the remaining area. Thus, the demodulating unit 80 may further comprise the modulation code detector 65 of FIG. 6 to detect from the sum signal S input via the first channel CH₁ whether the optical information storage medium comprises a plurality of different modulation codes. This modulation code detecting method detects types of modulation code included in the optical information storage medium by detecting the mark and the space having a length of nT, and the mark and the space having a length of 2nT recorded according to the bi-phase modulation method.

The structure and operation of the optical information reproducing apparatus performing reproduction from the above-described read-only optical information storage medium are the same as those of the optical information storage medium described with reference to FIG. 6, and a separate description thereof will not be provided.

During reproduction from the recordable optical information storage medium, the switch SW₁ is connected with a node T₂ to connect the wobble PID demodulator 85 to the signal processor 89. Here, the switch SW₂ is also connected with a node T₃ to connect the wobble PID demodulator 87 to the signal processor 89. Thus, when the optical spot is located in the PIC area of the lead-in area, the wobble PIC demodulator 85 is used. When the optical spot is located in the remaining area, the wobble PID demodulator 87 is used. Here, since data are recorded as different modulation codes in a wobble PIC area and a wobble PID area, the wobble PIC area is distinguishable from the PID area.

Whether an optical information storage medium is classified as the read-only optical information storage medium or the recordable optical information storage medium is determined depending on whether a wobbling signal is input via the second channel CH₂. When the wobbling signal is not input via the second channel CH₂, the optical information storage medium which is used is classified as the read-only optical information storage medium. Thus, information may be reproduced using only a signal input via the first channel CH₁. When the wobbling signal is input via the second channel CH₂, the used optical information storage medium is classified as the recordable information storage medium. Thus, information is reproducible using signals input via the first and second channels CH₁ and CH₂.

A method of reproducing information recorded on the read-only optical information storage medium and the recordable optical information storage medium will be described.

Here, the method of reproducing information from the read-only optical information storage medium has been described with reference to FIG. 5 and thus will not be further explained herein. The recordable optical information storage medium comprises a lead-in area, a user data area, and a lead-out area. Storage medium-related information is recorded as pit wobbles in the entire lead-in area or a portion of the lead-in area and recording- and reproduction-related user data are recorded in the remaining area of the reacordable optical information storage medium.

Referring to FIG. 8, the optical information reproducing method comprises determining a type of optical information storage medium which is used based on whether the wobbling signal is input via the second channel CH₂.

If the wobbling signal is not input via the second channel CH₂, the optical information storage medium is classified as the read-only optical information storage medium, a data signal input via the first channel CH, is demodulated using the data demodulator 81, and PIC data input via the first channel CH, is demodulated using the ROM-PIC demodulator 83.

When the wobbling signal is input via the second channel CH₂, recordable optical information storage medium-related information recorded as pit wobbles are demodulated from the differential signal D input via the second channel CH₂ using the wobble PIC demodulator 85. PID recorded as pit wobbles on the recordable optical information storage medium is demodulated from the differential signal D using the wobble PID demodulator 87. Here, modulation codes of the optical information storage medium are the same as those described with reference to FIGS. 5 and 6 and a description thereof will not be repeated.

The optical information reproducing method according to the present embodiment may comprise detecting from the signal input via the first channel CH₁ whether the optical information storage medium has a plurality of different modulation codes, using the modulation code detector 65 of FIG. 6. This modulation code detecting method detects what types of modulation codes are included on the optical information storage medium by detecting the mark and the space having a length of nT, and the mark and the space having a length of 2nT recorded according to the bi-phase modulation method.

The above-described optical information reproducing method according to the present invention is useable for an optical information storage medium having two or more information layers as well as for an optical information storage medium having a single information layer.

As described above, an optical information reproducing apparatus and method according to the present invention reproduces information from a read-only optical information storage medium in which storage medium-related information data are recorded as pit wobbles in the entire lead-in area or a portion of the lead-in area and data are recorded as general pits in the remaining area, i.e., in a user data area and a recordable optical information storage medium.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for reproducing information from an optical information storage medium which comprises a lead-in area, a user data area, and a lead-out area, whereon optical information storage medium-related information is recorded in at least a portion of the lead-in area and reproduction-related user data are recorded in a remaining area of the optical information storage medium, the apparatus comprising:
a light source which radiates a laser light beam;
an objective lens which condenses the laser light beam to be focused on the optical information storage medium;
a photodetector which receives the laser light beam reflected from the optical information storage medium and which comprises first and second photodiodes which independently convert a received optical signal into first and second electric signals, respectively;
a reproduction-related user (RRU) data demodulator which demodulates the reproduction-related user data from a sum signal of the first and second electrical signals; and
a read only memory-permanent information control (ROM-PIC) data demodulator which demodulates the optical information storage medium-related information from the sum signal.

2. The optical information reproducing apparatus of claim 1, wherein:
the RRU data demodulator reproduces the reproduction-related user data which is recorded on the optical information storage medium according to a run length-limited (RLL) modulation method, and
the ROM-PIC data demodulator reproduces the optical information storage medium-related information which is recorded on the optical information storage medium according to a bi-phase modulation method.

3. The optical information reproducing apparatus of claim 2, wherein the RLL modulation method is an RLL (1, 7) modulation method.

4. The optical information reproducing apparatus of claim 2, wherein the RLL modulation method is an RLL (2, 10) modulation method.

5. The optical information reproducing apparatus of claim 4, wherein the optical information storage medium-related information is recorded as a mark and a space having a length of nT, and a mark and a space having a length of 2nT, where n is an integer in a range where 2≦n≦8.

6. The optical information reproducing apparatus of claim 5, further comprising a modulation code detector which detects from the sum signal whether the optical information storage medium comprises a plurality of different modulation codes by detecting the mark and the space having the length of nT, and the mark and the space having the length of 2nT.

7. The optical information reproducing apparatus of claim 3, wherein the optical information storage medium-related information is recorded as a mark and a space having a length of nT, and a mark and a space having a length of 2nT, where n is an integer in a range where 2≦n≦8.

8. The optical information reproducing apparatus of claim 7, further comprising a modulation code detector which detects from the sum signal whether the optical information storage medium comprises a plurality of different modulation codes by detecting the mark and the space having the length of nT, and the mark and the space having the length of 2nT recorded according to the bi-phase modulation method.

9. The optical information reproducing apparatus of claim 2, further comprising a modulation code detector which detects from the sum signal whether the optical information storage medium comprises a plurality of different modulation codes by detecting the mark and the space having a length of nT, and the mark and the space having a length of 2nT recorded according to the bi-phase modulation method.

10. The optical information reproducing apparatus of claim 1, further comprising a modulation code detector which detects from the sum signal whether the optical information storage medium comprises a plurality of different modulation codes.

11. An apparatus for reproducing information from an optical information storage medium (OISM), wherein the OISM is one of a read-only OISM and a recordable OISM, the OISM comprising a lead-in area, a user data area, and a lead-out area and optical information storage medium-related information (OISMRI) is recorded as one of read-only OISMRI and recordable OISMRI in at least a portion of the lead-in area and reproduction-related user (RRU) data is recorded in a remaining area of the OISM, and where the OISM is the recordable OISM, the OISMRI is recorded as pit wobbles, the apparatus comprising:
a light source which radiates a laser light beam;
an objective lens which condenses the laser light beam to be focused on the one of the read-only OISM and the recordable OISM;
a photodetector which receives an optical signal reflected from the one of the read-only OISM and the recordable OISM and comprises first and second photodiodes which convert the received optical signal into independent electric signals;
a reproduction-related user (RRU) data demodulator which demodulates the RRU data from a sum signal of the electric signals; and
a read only memory-permanent information and control (ROM-PIC) data demodulator which demodulates the read-only OISMRI from the sum signal;
a wobble PIC demodulator which demodulates the recordable OISMRI which is recorded as pit wobbles, from a differential signal of the electrical signals; and
a wobble physical identification data (PID) demodulator which demodulates physical identification data which are recorded as pit wobbles on the recordable OISM, from the differential signal,
wherein:
where the OISM is the read-only OISM, the optical information reproducing apparatus reproduces information from the read-only OISM using signals obtained from the RRU data demodulator and the ROM-PIC data demodulator, and
where the OISM is the recordable OISM, the optical information reproducing apparatus reproduces information from the recordable OISM using signals obtained from the RRU data demodulator, the wobble PIC demodulator, and the wobble PID demodulator.

12. The optical information reproducing apparatus of claim 11, wherein the RRU data demodulator reproduces the reproduction-related user data which are recorded on the optical information storage medium according to a run length-limited (RLL) modulation method, and the ROM-PIC data demodulator reproduces the OISMRI which is recorded on the OISM according to a bi-phase modulation method.

13. The optical information reproducing apparatus of claim 12, wherein the RLL modulation method is an RLL (1, 7) modulation method.

14. The optical information reproducing apparatus of claim 13, wherein the OISMRI is recorded as a mark and a space having a length of nT, and a mark and a space having a length of 2nT, where n is an integer in a range where 2≦n≦8.

15. The optical information reproducing apparatus of claim 12, wherein the RLL modulation method is an RLL (2, 10) modulation method.

16. The optical information reproducing apparatus of claim 15, wherein the OISMRI is recorded as a mark and a space having a length of nT, and a mark and a space having a length of 2nT, where n is an integer in a range where 2≦n≦8.

17. The optical information reproducing apparatus of claim 12, wherein the OISMRI is recorded as a mark and a space having a length of nT, and a mark and a space having a length of 2nT, where n is an integer in a range where 2≦n≦8.

18. The optical information reproducing apparatus of claim 17, further comprising a modulation code detector which detects from the sum signal whether the OISM comprises a plurality of different modulation codes by detecting the mark and the space having the length of nT, and the mark and the space having the length of 2nT.

19. The optical information reproducing apparatus of claim 16, further comprising a modulation code detector which detects from the sum signal whether the optical information storage medium comprises a plurality of different modulation codes.

20. A method of reproducing information from an optical information storage medium which comprises a lead-in area, a user data area, and a lead-out area, wherein optical information storage medium-related information is recorded in the entire lead-in area or a portion of the lead-in area and reproduction-related user data are recorded in a remaining area of the optical information storage medium, the optical information reproducing method comprising:
radiating a laser light beam onto the optical information storage medium;
converting respective portions of an optical signal reflected from the optical information storage medium into independent electric signals;
demodulating the reproduction-related user data from a sum signal of electrical signals; and
demodulating the optical information storage medium-related information from the sum signal.

21. The method of claim 20, where the reproduction-related user data recorded according to an RLL modulation method on the optical information storage medium is reproduced in the demodulation of the reproduction-related user data, and the optical information storage medium-related information recorded on the optical information storage medium according to a bi-phase modulation method is reproduced in the demodulation of the optical information storage medium-related information.

22. The method of claim 21, wherein the RLL modulation method is an RLL (1, 7) modulation method.

23. The method of claim 22, wherein the optical information storage medium-related information is recorded as a mark and a space having a length of nT, and a mark and a space having a length of 2nT, where n is an integer in a range where 2≦n≦8.

24. The method of claim 21, wherein the RLL modulation method is an RLL (2, 10) modulation method.

25. The method of claim 24, wherein the optical information storage medium-related information is recorded as a mark and a space having a length of nT, and a mark and a space having a length of 2nT, where n is an integer in a range where 2≦n≦8.

26. The method of claim 20, further comprising a modulation code detector which detects from the sum signal whether the optical information storage medium comprises a plurality of different modulation codes by detecting a mark and a space having a length of nT, and a mark and the space having a length of 2nT recorded according to a bi-phase modulation method.

27. The method of claim 20, further comprising a modulation code detector which detects from the sum signal whether the optical information storage medium comprises a plurality of different modulation codes.

28. A method of reproducing information from an optical information storage medium (OISM), wherein the OISM is one of a read-only OISM and a recordable OISM, the OISM comprising a lead-in area, a user data area, and a lead-out area and optical information storage medium-related information (OISMRI) is recorded as one of read-only OISMRI and recordable OISMRI in at least a portion of the lead-in area and reproduction-related user (RRU) data is recorded in a remaining area of the OISM, and where the OISM is the recordable OISM, the OISMRI is recorded as pit wobbles, the method comprising:
radiating a laser light beam onto the one of the read-only OISM and the recordable OISM;
converting respective portions of the laser light beam reflected from the OISM into independent electric signals;
determining whether the read-only OISM or the recordable OISM is used based on whether a differential signal of the electrical signals comprises a wobbling signal;
demodulating the RRU data from a sum signal of the electrical signals;
demodulating the read-only OISMRI from the sum signal when the read-only OISM is used; and
where the recordable OISM is used, demodulating both the recordable OISMRI which is recorded as pit wobbles and physical identification data which are recorded as pit wobbles from the differential signal.

29. The method of claim 28, wherein the RRU data recorded according to an RLL modulation method on the OISM is reproduced in the demodulation of the RRU data, and the OISMRI recorded on the optical information storage medium according to a bi-phase modulation method is reproduced in the demodulation of the OISMRI.

30. The method of claim 29, wherein the RLL modulation method is an RLL (1, 7) modulation method.

31. The method of claim 30, wherein the OISMRI is recorded as a mark and a space having a length of nT, and a mark and a space having a length of 2nT, where n is an integer in a range where 2≦n≦8.

32. The method of claim 29, wherein the RLL modulation method is an RLL (2, 10) modulation method.

33. The method of claim 32, wherein information is recorded as a mark and a space having a length of nT, and a mark and a space having a length of 2nT, where n is an integer in a range where 2≦n≦8.

34. The method of claim 28, further comprising detecting from the sum signal whether the optical information storage medium comprises a plurality of different modulation codes by detecting the mark and the space having a length of nT, and the mark and the space having a length of 2nT.

35. The method of claim 28, further comprising detecting from the sum signal whether the optical information storage medium comprises a plurality of different modulation codes.

36. An apparatus for reproducing information, the apparatus comprising:
an optical information storage medium (OISM), the OISM comprising a lead-in area, a user data area, and a lead-out area wherein optical information storage medium-related information (OISMRI) is recorded in at least a portion of the lead-in area as pit wobbles and reproduction-related user (RRU) data is recorded in a remaining area of the OISM;
an optical system which converts an optical signal reflected from the OISM into first and second independent signals;
a reproduction-related user (RRU) data demodulator which demodulates the RRU data from a sum signal of the first and second independent signals;
a read only memory-permanent information and control (ROM-PIC) data demodulator which demodulates the OISMRI from the sum signal;
a wobble PIC demodulator which demodulates the OISMRI from a differential signal of the first and second independent signals;
a wobble physical identification data (PID) demodulator which demodulates physical identification data which are recorded as pit wobbles; and
a signal processor which outputs a reproduction signal in response to an output of the RRU data demodulator and selected ones of the ROM-PIC data demodulator, the wobble PIC demodulator and the wobble PID demodulator.

37. The apparatus of claim 36, further comprising:
a first switch which selectively connects the ROM-PIC demodulator and the wobble PIC demodulator to the signal processor; and
a second switch which selectively connects the wobble PID demodulator to the signal processor, wherein:
during reproduction from a read-only OISM, the first switch connects the ROM-PIC demodulator to the signal processor, and the second switch makes no connection, and
during reproduction from a recordable optical information storage medium, the first switch connects the wobble PID demodulator to the signal processor and the second switch connects the wobble PID demodulator.

38. The apparatus of claim 37, further comprising:
a modulation code detector which determines whether the sum signal comprises a plurality of different modulation codes, wherein:
the connections of the first and second switches are determined in response to the determination of the plurality of modulation codes.
